(19) United States
(12) Patent Application Publication
(10) Pub. No.: US 2006/0069640 A1
(43) Pub. Date: Mar. 30, 2006

(54) System and method for providing loan consolidation

(76) Inventors: Vicki Fitzgerald, Fishers, IN (US); Tamara Gilbert, Fishers, IN (US); Julie Nevitt, Noblesville, IN (US); Amy Perry, Pendleton, IN (US); Janet Sorg, Fishers, IN (US); Colleen Watson, Fishers, IN (US); Michelle Ancil, Noblesville, IN (US); Tracy Kamleiter, Shelleyville, IN (US); Janet Mikeworth, Mooresville, IN (US); Jim Rang, Noblesville, IN (US); Diane Capps, Indianapolis, IN (US); Tony Marichal, Carmel, IN (US); Chris Thieman, Noblesville, IN (US); Heather Graham, Fortville, IN (US); Stacy Gibson, Westfield, IN (US); Keith D'Ambra, Carmel, IN (US); John D. Pittman, Greenwood, IN (US); Robert Autor, Carmel, IN (US); Chester Gorski, Carmel, IN (US)

Correspondence Address: DICKSTEIN SHAPIRO MORIN & OSHINSKY LLP, 2101 L Street, NW, Washington, DC, 20037, US

(21) Appl. No.: 11/230,549

(22) Filed: Sep. 21, 2005

Related U.S. Application Data
(60) Provisional application No. 60/612,512, filed on Sep. 24, 2004.

(51) Int. Cl. G06Q 40/00

(52) U.S. Cl. 705/38

(57) ABSTRACT

The present invention provides a computer-based system and method for providing processing loan consolidation applications. The method includes accepting a consolidation application from a borrower, the consolidation application containing information about a borrower and underlying loans to be consolidated. The application is validated to determine that the consolidation application is complete. Payoff information is obtained for the underlying loans and a disbursement date for the consolidated loan is set based on the payoff information. The lender of the consolidation loan is automatically determined. Funding to payoff the underlying loans is requested from the lender. The underlying loans are consolidated into the consolidated loan and payment information is received regarding the payoff of the underlying loans.

### FIELD OF THE INVENTION

The present invention relates to financial aid online application processes and specifically, to a method and system for providing loan consolidations to borrowers.

### BACKGROUND OF THE INVENTION

Almost all students attending college acquire some sort of educational financing. For this reason, there is a large market for financial aid financing during the educational experience and for loan consolidation options upon graduation. Many students after graduation are faced with numerous loans to repay after graduation and are looking for alternative methods of combining the loans to make repayment cheaper and feasible. As a result, lending institutions would not only like to offer such programs, but would like to have an efficient and effective method of processing a borrower's loans and consolidating them into one single loan.

With the advent of the internet, it is now possible for lenders to provide online applications and processing systems to their customers. While this is to the advantage of the customer, it is also to the advantage of the lender because the use of these electronic methods of applications and processing are time and cost effective.

Consolidation programs have become a good way for lending institutions to encourage borrowers to borrow money during school and have a reasonable method of repaying these loans after graduation. However, managing a consolidation program can become cumbersome and complicated, particularly where there are a large number of loans to be consolidated and disbursed. For this reason, there is a need for a computer program that can provide and manage a consolidation program efficiently and effectively.

### BRIEF SUMMARY OF THE INVENTION

The present invention provides a computer-based system and method for processing loan consolidation applications. The method includes accepting a consolidation application from a borrower, the consolidation application containing information about a borrower and underlying loans to be consolidated. The application is validated to determine that the consolidation application is complete. Payoff information is obtained for the underlying loans and a disbursement date for the consolidated loan is set based on the payoff information. The lender of the consolidation loan is automatically determined. Funding to payoff the underlying loans is requested from the lender. The underlying loans are consolidated into the consolidated loan and payment information is received regarding the payoff of the underlying loans.

### BRIEF DESCRIPTION OF THE DRAWINGS

The foregoing and other advantages of the invention will become more apparent from the detailed description of exemplary embodiments provided below with reference to the accompanying drawings in which:

FIG. 1 is a block diagram overview of the system and environment, according to an exemplary embodiment of the invention;

FIG. 2 is a block diagram overview of the method, according to an exemplary embodiment of the invention;

FIG. 3 is a block diagram of the method containing the steps related to the loan consolidation workflow imaging, according to an exemplary embodiment of the invention; and

FIG. 4 is a block diagram of the method containing the steps related to a consolidation application process, according to another embodiment of the invention.

### DETAILED DESCRIPTION OF THE INVENTION

The present invention provides a computer-based system and method for providing loan consolidation services. The term “lender” refers to an institution that provides funds to the borrower. The term “servicer” refers to an institution that services loans. The term “borrower” refers to a person who receives or has received a loan.

An exemplary embodiment of the invention is described as follows.

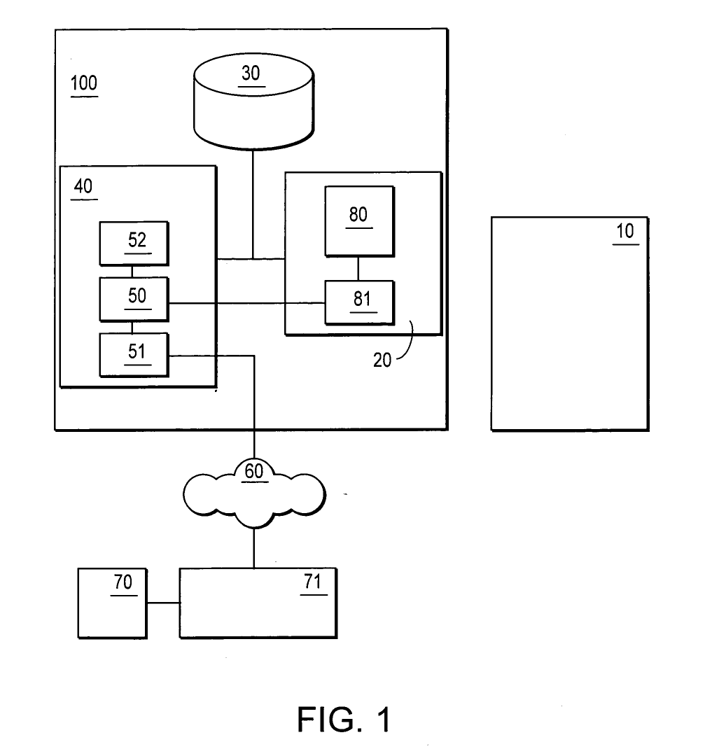

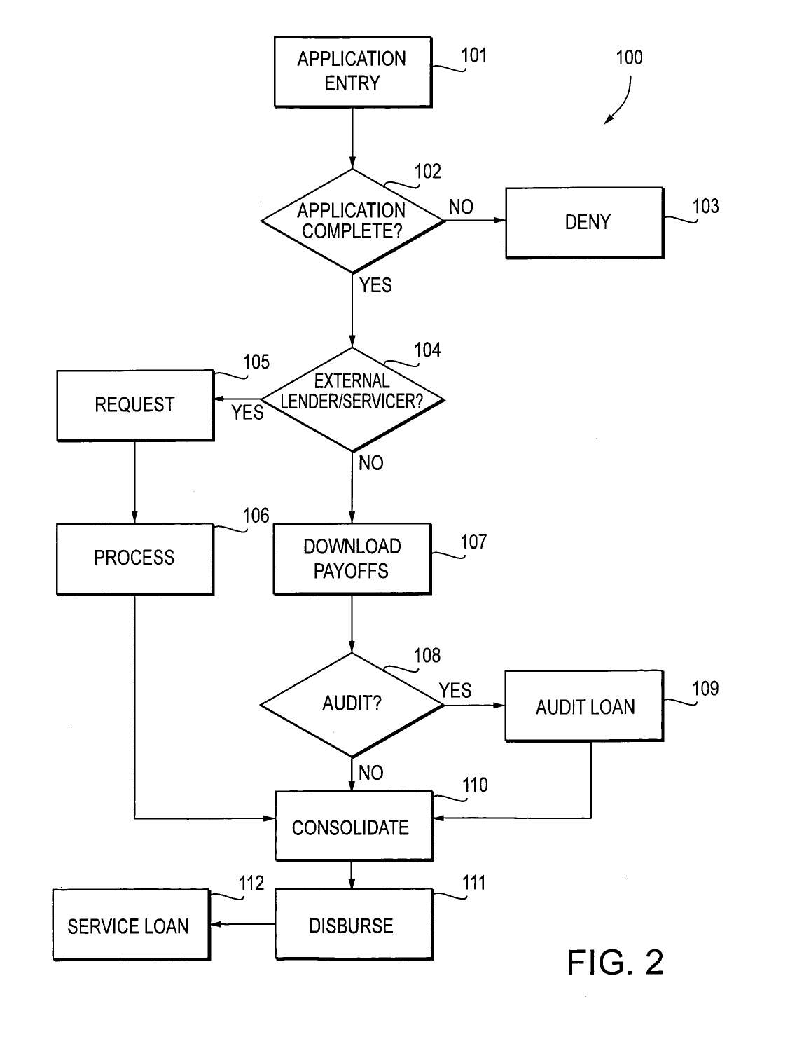

FIGS. 1 and 2 show a loan consolidation system and method according to an exemplary embodiment of the invention. FIG. 1 is a block diagram depicting the loan consolidation system 100. FIG. 2 illustrates a broad overview of a loan consolidation process. The system 100 can be implemented as the framework for an educational loan consolidation system. In such a case, the borrower is typically a student.

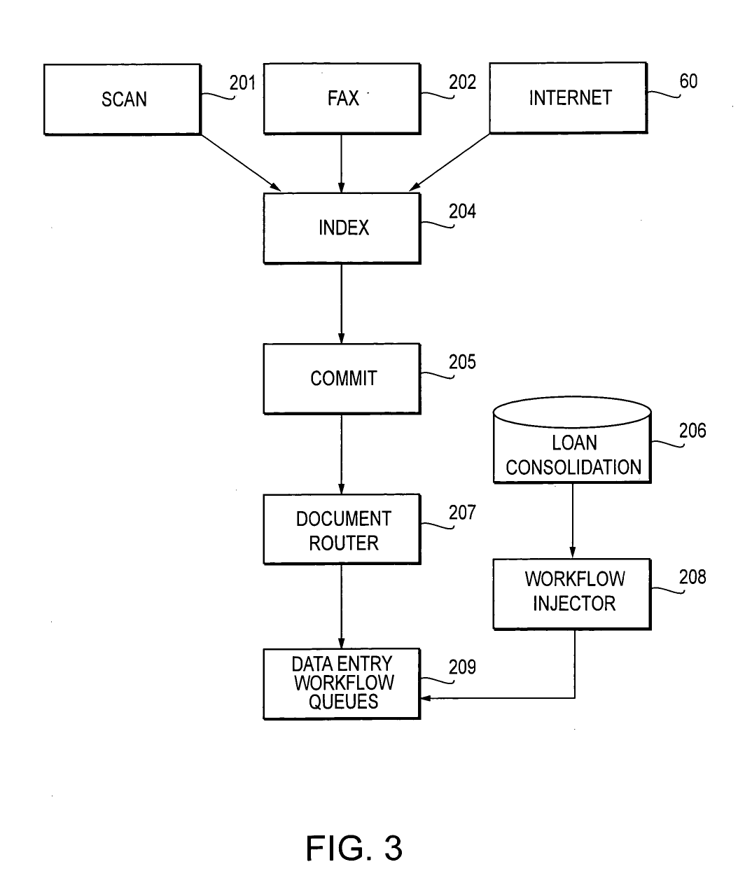

The system 100 is managed by an entity 10 and comprises one or more storage devices 30 and a server 40. The server 40 hosts a consolidation module 50 and a Single Workflow Imaging (SWI) module 52. The consolidation module 50 can be a computer program application running on the server 40 and capable of causing the system 100 to perform the functions as described herein to achieve the processes described below. The SWI module allows the entry and management of documents within the system 100 thereby enabling a paperless work environment. The SWI module 52 is described in more detail below in connection with FIG. 3. The system 100 also includes a website 51 running a server 50. The web site 51 provides a user interface for borrowers 70 to interact with the system 100 via the Internet 60.

The system 100 further includes a computer network 20 comprising an internal servicing component 80. The internal servicing system is a system by which the entity 10, e.g., a lender or servicer, manages and services loans. For simplicity, the entity 10 is referred to herein as a lender, but could instead be a different type of entity. The computer network 20 has a user interface 81 by which the lender 10 interacts with system 100, the internal servicing component 80, and the SWI module 52.

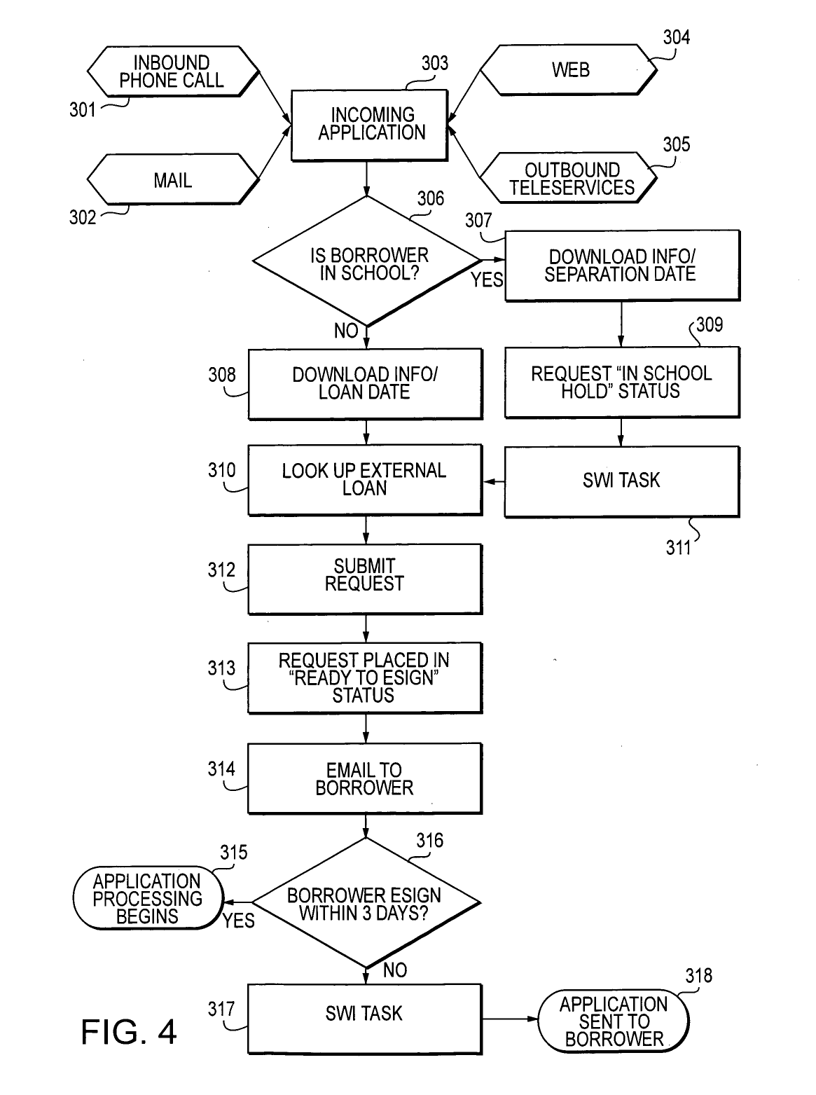

Referring to FIG. 2, borrowers 70 can submit a loan consolidation application by any suitable means, e.g. via the Internet 60, interactive voice response (IVR), telephone, or in writing at step 101. Preferably, the borrower 70 applies via the Internet 60 using client computer 71 (FIG. 1) and e-signs the application using the online loan application. Alternatively, the borrower 70 can request that the lender partially complete the application and return the partially complete application to the borrower 70 for signature. A request process according to the invention is described below in connection with FIG. 4.

Whether a borrower 70 applies online or by another method, the lender 10 processes all applications using the consolidation system 100. If the borrower 70 completes an online application, the application data is automatically entered into the system 100 and stored in the storage device 30. Alternatively, the lender 10 may manually enter application data provided by the borrower 70 into the system 100 to be stored in the storage device 30. Additionally, a copy of the application document is stored in the storage device 30. The entry and processing of an application document, and other documents associated with a consolidation account is described in more detail below in connection with FIG. 3.

In step 102, the consolidation module 50 validates application data immediately upon entry of data throughout the consolidation process and determines whether the application was complete. For this, the consolidation system 100 invokes a series of validation edits and business rule logic that reside within the consolidation module 50. The validation edits and business rule logic allow for automatic notification and for correction of errors. When a borrower 70 uses an online application, the consolidation module 50 monitors the application for potential errors, e.g., missing information.

In step 103, if critical information on the consolidation application is incomplete, an attempt is made to obtain this information from the borrower 70. A detected error triggers a notification to the borrower 70 of the error and requires that the borrower 70 correct the error. In one embodiment, the consolidation module 50 monitors the application in real time and notifies the borrower 70 of the error during the application process. Alternatively, when an error is detected in an electronic application, the consolidation module 50 automatically notifies the borrower 70 of the error and returns the application by electronic mail. Alternatively, where the borrower applied by phone or by mail, the consolidation module 50 will generate a letter in printed format to the borrower 70 advising the borrower that the application process has been halted until the required information is obtained. The lender 10 can them mail the letter and incomplete application to the borrower 70. Regardless of the method of application, if the application is not complete, it will be denied and returned to the borrower 70. If the missing information is still not received after a certain number of days, the loan is placed into a “Returned” status.

At step 104, once the complete application is received, the disbursement date is set. The setting of the disbursement date is passed on whether the underlying loans belong to the lender hosting the system 10 or an external lender. In the illustrated embodiment, the module 50 automatically sets the date if the application was generated through the e-sign process and the underlying loans being consolidated all belong to the lender 10 hosting the system 100. On the other hand, the disbursement date is set and manually entered into the system 100 by the lender 10 if any of the underlying loans being consolidated are external loans serviced by some entity other than the lender 10.

If the underlying loans are not serviced by lender 10, the lender 10 sends Loan Verification Certificates (LVCs) such as bar-code certificates to the external lenders or servicers (i.e., lenders and servicers other than lender 10) requesting the necessary payoff information. In step 105, the LVCs are sent by mail or automatically sent by fax or electronically by the consolidation module 50 to the respective external lender or servicer.

Once the payoff information is received, in step 106 the lender 10 then enters the payoff data into the system 100 by, for example, manually keying it or downloading it into the system 100. The payoff data includes, for example, the current lender, the outstanding balance good through the disbursement date, the interest rate and any guarantor information. If the payoff information is not received within 30 days of the original or latest request for the payoff, the consolidation module 50 automatically resends the LVCs to the external lenders and servicers until the request has been satisfied. Once the payoff data is in the system 100, the consolidation module 50 sets the underlying loan for disbursement.

In the illustrated embodiment, the lender 10 has a loan servicing component 80 for managing and servicing loans. In step 107, the internal servicing component 80, allows for an automated download of payoff information for the underlying loans that are serviced by the lender 10. This automation minimizes the data entry errors that can occur and the time consuming task of data entry. If the application is generated and correctly filled out through the e-sign process and the borrower's underlying loans are serviced by the lender 10, the consolidation module 50 automatically retrieves the payoff information from the loan servicing component 80 and the underlying loans are set for disbursement by the consolidation module 50 without any manual intervention.

In steps 108 and 109, the lender 10 can manually audit original loan data and consolidation details for a consolidation account. If errors are assessed, they are entered into the consolidation module 50 and the consolidation module 50 then returns the files through the process, beginning at step 104 for correction. When all errors are resolved, the account is placed into a “Ready to Consolidate” status and the consolidation module 50 automatically balances the amount of the underlying loans with the amount of loans in the “Ready to Consolidate” status to ensure that data integrity is maintained throughout the process. The consolidation module 50 can also perform a number of checks before finalizing and submitting the loan consolidation.

After the payoffs are entered into the consolidation system 100 and placed into the “Ready to Consolidate” status, in step 110 the consolidation module 50 automatically determines the lender and guarantor for the new consolidated loan based on a set of rules. The lender for the new consolidated loan can be lender 10. In one embodiment, the rules are configured to determine the lender and guarantor based on the entity that owns the largest percentage of the underlying loans being consolidated. The rules can also include single holder checks; lender requirements, including dollar minimums; and guarantor assignment based on contracts and loan program rules.

Additionally, once the payoffs are entered, the consolidation module 50 automatically determines if the loans are eligible to consolidate based on the loan requirements and federal regulations governing the consolidation program and automatically excludes loans that are ineligible. If the loan is found to be eligible, the consolidation module 50, transmits an electronic funding request to the lender identified by the consolidation module detailing the amount that needs to be funded. The electronic funding request contains information regarding the entity that should receive the payment and the payment amount.

After the lender for the new consolidated loan has issued payments at step 111, information containing the issued payment ID number is imported or manually entered into the consolidation module 50. The consolidation module 50 automatically, or at the direction of the lender 10, generates a report containing the payment ID numbers and payoff information and is distributed to the holders of the underlying loans. In step 112, if the consolidated loan is to be serviced by lender 10, once disbursed, the consolidation account is automatically sent to the internal servicing component 80 so that the new consolidation loan can be managed and serviced. In servicing the consolidated loan, repayment schedule disclosure statements are generated and the billing information is automatically forwarded to the borrower 70 by the loan servicing component 80.

In one embodiment, if needed during the consolidation application processing, the consolidation module 50 can generate letters and forms for borrowers 70. The lender 10 can select a particular type of template letter or form to print via the consolidation module 50. For example, where the borrower 70 must be notified that the consolidation application contains an error or is incomplete, the consolidation module 50 can generate a letter to the particular borrower 70 based on a template letter. The system 100 queries the database 30 and consolidation module 50 to determine which borrowers 70 should receive that particular letter or form and passes demographic and any required variable information to the letter or form. Both pre-printed and system-generated forms are used. For letters, templates are stored as, for example, Microsoft Word documents on the local area network (LAN) in a restricted directory. Using this embodiment, the text for a particular letter can be easily generated and/or changed. It also greatly reduces the time needed to create a new letter from the consolidation module 50. Moreover, certain high-volume letters and forms are automatically generated from the consolidation module 50 without any user intervention such as repayment schedule disclosure statements and billing information.

FIG. 3 depicts the process for entering loan consolidation applications and other documents into the system 100 and processing of the applications and documents by the SWI module 52. Upon receipt of applications, loan verification certificates, and any other consolidation-related correspondence by scan 201, fax 202 or Internet 60, the documents are scanned and indexed in step 204 by the lender 10 into the SWI module 52 (FIG. 2) where, after being committed, they are automatically routed to the consolidation system 100 for processing.

In step 205, the lender 10 commits the documents. Committing is the process of assigning unique identification data to a batch and/or each document within a batch to facilitate storage, retrieval and workflow processing. The SWI module 52 stores an image of each document in the storage device 30 or on an optical disk (not shown) and creates a document image, which can be viewed and processed online and via the user interface 81. The image of these scanned documents is retained within the consolidation system 100 in storage device 30 for future reference. In step 207, certain document images are then routed to appropriate work queues based on the status of existing consolidation applications for a borrower 70 associated with the documents within the loan consolidation system 100.

Once the loan consolidation application is complete 206, the collected documents are forwarded to a work flow injector. In step 208, the system 100 can sort the processing documents based on certain criteria. The workflow injector process, as it is called, creates manual workflow tasks for the appropriate work queues based on events occurring within the loan consolidation system 100. The manual workflow tasks are those tasks that require manual intervention by the lender 10 or lender employees. For example, in the illustrated embodiment, employee processors of the lender 10 are responsible for completing and/or managing the tasks in the work queues.

Examples of workflow tasks include entering consolidation application data into the system 100 based upon the receipt of a non-electronic consolidation application; performing a manual audit; entering payoff information received from an external lender or servicer in response to a LCV, among others. For these tasks the document images associated with the relevant consolidation accounts are automatically routed to the appropriate work queues so that the tasks can be completed easily and without the need for paper files.

FIG. 4 illustrates a process for requesting a partially completed loan consolidation application from lender 10. According to one embodiment of the invention, the system 100 can accept applications for future consolidation. Sometimes, loans may not be consolidated before a particular event has occurred, such as a certain period of time has passed. In particular, federal student loans may not be consolidated before the borrower 70 has graduated or left school. The present system 100 allows borrowers 70 to apply to consolidate loans prior to the occurrence of the event, e.g., prior to graduating or leaving school. The borrower 70 can apply to consolidate loans using the method described in connection with FIG. 4.

Referring to FIG. 4, borrowers 70 (including those not yet eligible to consolidate their loans since they are in “in-school” status) can request a partially completed loan consolidation application via the Internet 60 at step 304, IVR at step 305, incoming/outbound telephone at step 301, or by mail at step 302. Once the application request is received by the system 100, the consolidation module 50 determines whether the borrower 70 is in school at step 306.

If the borrower 70 is not in school, the consolidation module downloads any information regarding the borrower 70 and the borrower's loans from the servicing component 80 at step 308. Any available information is placed into the consolidation application. At step 310, information regarding the borrower's loans is retrieved from the National Student Loan Data System (NSLDS) and entered into the consolidation application.

If the borrower 70 is determined to be in school, then the consolidation module 50 downloads any current information regarding the borrower 70 and the borrower's loans from the servicing component 80 at step 307. The consolidation module 50 then places the application request on “in-school hold” status at step 309. Once the borrower has graduated or left school, the SWI module 52 creates a workflow task for the application to be more fully completed and sent to the borrower 70. Specifically, information regarding the borrower's loans is retrieved from the NSLDS and entered into the consolidation application.

Once the consolidation module has partially completed the application, it is sent to the borrower 70 on or after his/her separation date from school for a signature at step 314. Preferably, the application is an electronic application and the consolidation module 51 automatically sends an email to the borrower 70. The email can contain a link to the on-line application where the borrower 70 can e-sign the application.

If the borrower e-signs the application, it is processed as described above in connection with FIG. 2. If, however, at step 316, the borrower 70 does not e-sign the application within the prescribed timeframe (e.g., 3 days), then the SWI module 52 creates a workflow task at step 317 for the application to be printed and mailed to the borrower 70 for signature at step 318.

It should be appreciated that the educational loan embodiment described here is not the only use of this invention. The invention can be used to support any type of consolidation application process including but not limited to multiple loan consolidation programs within any type of industry that uses loan financing such as financing an automobile, real estate, personal debt, etc.

Having described specific preferred embodiments of the invention with reference to the accompanying drawings, it is understood that the invention is not limited to those precise embodiments, and that various changes and modifications may be effected therein by one skilled in the art without departing from the scope or the spirit of the invention as defined in the appended claims.

What is claimed as new and desired to be protected by Letters Patent of the United States is:

1. A system for consolidating loans, the system comprising:
a computer network;
at least one server in communication with the computer network;
a storage device for storing information;
at least one website located on the at least one server, wherein the website provides a user interface through which a borrower can access a consolidation application and electronically sign the consolidation application; and
a consolidation module for facilitating the consolidation of the borrower's underlying loans by determining the whether the consolidation application is complete, determining the lender and guarantor for a consolidation loan, and determining whether the underlying loans are eligible for consolidation.

2. The system of claim 1, further comprising a user interface through which the lender can access an online application and manually enter information regarding a loan consolidation for the borrower.

3. The system of claim 1, wherein the consolidation module further comprises a series of validation edits and business rule logic checks.

4. The system of claim 1, further comprising an imaging device in communication with the storage device, the imaging device enabling an image of the application to be stored in the storage device.

5. The system of claim 1, further comprising a single workflow imaging module in communication with the storage device for accepting images of documents associated with the consolidation application, and storing the images on the storage device.

6. The system of claim 5, wherein the single workflow imaging module is configured to assign unique identification data to each one of a plurality of documents to facilitate storage, retrieval and workflow processing.

7. The system of claim 1, wherein the consolidation module is configured to generate repayment schedule disclosure statements for a consolidation loan.

8. The system of claim 1, wherein, pursuant to a request by a borrower for a consolidation application, the consolidation module is configured to determine whether conditions for consolidating the underlying loans have been met.

9. The system of claim 8, wherein at least one condition is that the borrower has graduated or left school.

10. The system of claim 8, wherein if the condition has not been met, the consolidation module will determine when the condition is met and will automatically proceed to process the consolidation application once the condition is met.

11. The system of claim 8, further comprising a loan servicing component for servicing and maintaining information about underlying loans.

12. A method of providing a consolidation loan for borrowers, the method comprising the steps of:
accepting a consolidation application from a borrower, the consolidation application containing information about a borrower and underlying loans to be consolidated;
validating the consolidation application to determine that the consolidation application is complete;
obtaining payoff information for the underlying loans;
setting a disbursement date for the underlying loans based on the payoff information;
automatically determining a lender of a consolidation loan;
automatically requesting funding to payoff the underlying loans from the lender;
consolidating the amounts of the plurality of loans into a consolidated loan; and
receiving payment information regarding the payoff of the underlying loans.

13. The method of claim 12, wherein the accepting step further comprises:
scanning an image of the consolidation application;
indexing the consolidation application image; and
storing the consolidation application image within a storage medium.

14. The method of claim 13, wherein the indexing step comprises
assigning unique identification data to the consolidation application image to facilitate storage, retrieval and workflow processing.

15. The method of claim 12, wherein the act of accepting comprises accepting an electronic application via the Internet.

16. The method of claim 12, wherein the act of obtaining payoff information comprises automatically accessing payoff information within a loan servicing component.

17. The method of claim 16, wherein the disbursement date is automatically set.

18. The method of claim 12, further comprising the act of automatically transferring the consolidated loan to a loan servicing component for servicing.

19. The method of claim 18, further comprising the acts of generating a repayment schedule disclosure statement and sending billing information to the borrower.

20. A computer program transmitted over a communication medium to a computer system, the computer system comprising a storage device and a processor in communication with the storage device, the computer program causing the processor to perform the acts of:
accepting a consolidation application from a borrower, the consolidation application containing information about a borrower and underlying loans to be consolidated;
validating the consolidation application to determine that the consolidation application is complete;
obtaining payoff information for the underlying loans;
setting a disbursement date for the underlying loans based on the payoff information;
automatically determining a lender of a consolidation loan;
automatically requesting funding to payoff the underlying loans from the lender;
consolidating the amounts of the plurality of loans into a consolidated loan; and
receiving payment information regarding the payoff of the underlying loans.

21. The method of claim 20, wherein the accepting step further comprises:
scanning an image of the consolidation application;
indexing the consolidation application image; and
storing the consolidation application image within a storage medium.

22. The method of claim 21, wherein the indexing step comprises assigning unique identification data to the consolidation application image to facilitate storage, retrieval and workflow processing.

23. The method of claim 20, wherein the act of accepting comprises accepting an electronic application via the Internet.

24. The method of claim 20, wherein the act of obtaining payoff information comprises automatically accessing payoff information within a loan servicing component.

25. The method of claim 24, wherein the disbursement date is automatically set.

26. The method of claim 20, further comprising the act of automatically transferring the consolidated loan to a loan servicing component for servicing.

27. The method of claim 26, further comprising the acts of generating a repayment schedule disclosure statement and sending billing information to the borrower.
